(19) United States
(12) Patent Application Publication
(10) Pub. No.: US 2026/0065911 A1
(43) Pub. Date: Mar. 5, 2026

(54) METHOD OF CONTROLLING HOME APPLIANCE BASED ON COMMAND AND DEVICE FOR IMPLEMENTING THE SAME

(71) Applicant: LG Electronics Inc., Seoul (KR)

(72) Inventor: Eunah LEE, Seoul (KR)

(73) Assignee: LG Electronics Inc., Seoul (KR)

(21) Appl. No.: 19/319,149

(22) Filed: Sep. 4, 2025

(30) Foreign Application Priority Data
Sep. 5, 2024 (KR) 10-2024-0120824
Apr. 10, 2025 (WO) PCT/KR2025/004910

(51) Int. Cl. G10L 15/22; G10L 15/01; G10L 15/18

(52) U.S. Cl. CPC G10L 15/22; G10L 15/01; G10L 15/1815; G10L 2015/223

(57) ABSTRACT

A method for controlling an electronic device can include receiving a user input, in response to the user input corresponding to the direct control command, and executing a function corresponding to the direct control command. Also, the method can include in response to the user input corresponding to the non-direct control command, extracting, at least one sample text from a database having a similarity score relative to the user input that is greater than or equal to a predetermined threshold, and providing a prompt to a generative artificial intelligence (AI) module, the prompt including the user input, a guide associated with a command category, and the at least one sample text, receiving, from the generative AI model, a result based on the prompt for generating a control command, the result including an interpreted command category, and executing, by the electronic device, a function corresponding to the control command.

### CROSS-REFERENCE TO RELATED APPLICATIONS

This application claims priority under 35 U.S.C. § 119 to and the benefit of Korean Patent Application No. 10-2024-0120824, filed in the Republic of Korea on Sep. 5, 2024, and PCT Application No. PCT/KR2025/004910 filed on Apr. 10, 2025, the entireties of which are incorporated herein by reference.

### BACKGROUND

### Technical Field

The present invention relates to a method of controlling a home appliance based on a command and a device for implementing the same.

### Description of the Related Art

Control methods for devices such as home appliances can be classified into a control method through direct human manipulation and a control method through natural language commands. In the situation of the direct manipulation, a user can control the operation of the home appliance by manipulating a remote controller, buttons or dials on the home appliance, etc. In the situation of the natural language command control, when the user inputs natural language commands to the home appliance, the home appliance recognizes and operates the commands.

However, the natural language commands uttered or input by the user vary from person to person, making it difficult to interpret and translate these commands into actual commands. In particular, the accuracy of natural language command interpretation depends on past command input habits and home appliance usage environment of each user.

In other words, existing methods for controlling home appliances through natural language commands present significant challenges, such as accurately interpreting user intent. The inherent variability in human speech can create some ambiguity that can lead to incorrect command execution or recognition failure. Also, many existing systems are constrained by a reliance on rigid, predefined command structures that force the user to memorize specific phrases. This lack of flexibility prevents the system from understanding novel phrasings or compound instructions, which prevents a seamless and intuitive user interaction with the device.

Thus, a need exists for a method and device for interpreting the intent of a command uttered by a user, generating a corresponding control command, and controlling a home appliance using the control command.

Also, a need exists for an improved method that can dynamically interpret a wide range of natural language inputs, adapt to individual user speech patterns, and accurately translate ambiguous commands into precise device operations.

### SUMMARY OF THE DISCLOSURE

The present specification is directed to solving the above problems and improving speech recognition errors and enabling flexible user command recognition.

In addition, the present specification enables the simultaneous operation of multiple controls when user commands are processed.

In addition, the present specification enables the user to control home appliances through voice recognition even when the user does not use predefined commands.

Objects of the present invention are not limited to the above objects, and other objects and advantages of the present invention that are not described can be understood by the following description and will be more clearly understood by embodiments of the present invention. In addition, it will be able to be easily seen that the objects and advantages of the present invention can be achieved by devices and combinations thereof that are described in the claims.

According to one embodiment of the present invention, there is provided a method of controlling a home appliance that can dynamically interpret a wide range of natural language inputs, adapt to individual user speech patterns and accurately translate even ambiguous commands into precise device operations.

According to one embodiment of the present invention, there is provided a method of controlling a home appliance based on a command includes a first operation of determining, by an electronic device, whether an input command corresponds to direct control, a second operation of inputting, by the electronic device, a guide including a category for the command together with the command and a sample text having similarity greater than or equal to a predetermined reference value with the input command extracted from a database to a generative AI module when the command input in the first operation does not correspond to the direct control, and a third operation in which a result generated by the generative artificial intelligence (AI) module includes the category of the input command and which generates a control command using the generated result.

According to one embodiment of the present invention, there is provided a server for controlling a home appliance based on a command, including a server control unit configured to determine an input command and generate a corresponding control command, a database in which a plurality of sample texts are stored, and a server communication unit configured to communicate with a home appliance, in which, after the server communication unit receives a command input to the home appliance from the home appliance, the server control unit inputs a guide including a category for the command together with the command and a sample text having similarity greater than or equal to a predetermined reference value with the input command extracted from a database to a generative AI module when the command input in the first operation does not correspond to the direct control, a result generated by the generative artificial intelligence (AI) module includes a category of the input command, the server control unit generates a control command using the generated result, and the server communication unit transmits the control command to the home appliance so that the home appliance provides a function according to the generated control command.

When embodiments of the present invention is applied, it is possible to improve speech recognition errors, thereby enabling flexible recognition of user commands.

When embodiments of the present invention is applied, it is possible to enable simultaneous operation of various controls when user commands are processed.

When embodiments of the present invention is applied, home appliances can be controlled through voice recognition even when the user does not use predefined commands.

Effects of the present invention are not limited to the above effects, and various effects of the present invention can be derived from the configuration of the present invention.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a view showing a process in which a home appliance operates upon receiving a command according to an embodiment of the present invention.

FIG. 2 is a view showing a process in which, upon receiving a command, a home appliance transmits the command to a server, receives a control command from the server, and then operates accordingly according to another embodiment of the present invention.

FIG. 3 is a view showing a configuration of the server according to an embodiment of the present invention.

FIG. 4 is a view showing classification of input commands according to an embodiment of the present invention.

FIG. 5 is a view showing a process in which the server processes the input commands according to an embodiment of the present invention.

FIG. 6 is a view showing a structure of a prompt according to an embodiment of the present invention.

FIG. 7 is a view showing an example description of a base according to an embodiment of the present invention.

FIG. 8 is a view showing a flowchart for interpreting the input commands using a generative artificial intelligence (AI) module according to an embodiment of the present invention.

FIG. 9 is a view showing a detailed operation process of the server according to an embodiment of the present invention.

FIG. 10 is a view showing a configuration of the home appliance according to an embodiment of the present invention.

### DETAILED DESCRIPTION OF THE EMBODIMENTS

Hereinafter, embodiments of the present invention will be described in detail with reference to the accompanying drawings so that those skilled in the art to which the present invention pertains can carry out the present invention. The present invention can be implemented in various different forms and is not limited to the embodiments described herein.

In order to clearly describe the present invention, parts not related to the description have been omitted, and the same or similar components are denoted as the same reference numerals throughout the specification. Hereinafter, some embodiments of the present invention will be described in detail with reference to exemplary drawings. In adding reference numerals to components in each drawing, the same components can have the same reference numerals as much as possible even when they are shown in different drawings. In addition, in the description of the present disclosure, when it is determined that a detailed description of a related known configuration or function can obscure the gist of the present disclosure, detailed description thereof can be omitted.

In the description of the components of the present invention, terms such as “first,” “second,” “A,” “B,” “(a),” “(b),” and the like can be used. These terms are only for the purpose of distinguishing one component from another component, and the nature, sequence, order, or the like of the corresponding component is not limited by these terms. When a certain component is described as being “connected,” “coupled,” or “joined” to the other component, the component can be directly connected or joined to the other component, but it should be understood that another component can be “interposed” between the components, or the components can be “connected,” “coupled,” or “joined” through another component.

In addition, the components can be sub-divided for convenience of description in implementing the present invention, but these components can be implemented within a single device or module, or a single component can be implemented by being divided into multiple devices or modules. The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

Hereinafter, a home appliance described herein is a device including an electronic product. The home appliance can be disposed in homes, offices, or the like and moved and disposed in other locations by people.

The device described herein, for example, a home appliance or a server device, preprocesses a voice command or text command input by a user, classifies the input command (input user command) into a specific category, interprets the input command according to the classified category, and controls the home appliance to operate in response to the interpreted result.

The home appliance, the server device (server), or a system composed of one or more devices can store hardware or software for processing feature commands. In addition, the home appliance, the server device (server), or the system composed of one or more devices can receive and execute software for processing feature commands from a remote third device. Processing feature commands using hardware embedded in the device, software stored within the device, or executable software transmitted can be performed by a processor within each device. Alternatively, these hardware or software can operate as processors.

To this end, the processor can store software or program code capable of performing the above tasks. After such software or program code is received from another external device and stored in a storage medium used by the processor, the processor can execute the software or program code.

In addition, the processor can include a hardware component, such as a programmable chip, and the processor can store data, program code, and the like, which will be input to the hardware component, in a predetermined storage medium and input the data, the program code, and the like to the hardware component.

The hardware or software can be the processor itself. Alternatively, the hardware or software can be linked with the processor to implement embodiments of the present invention.

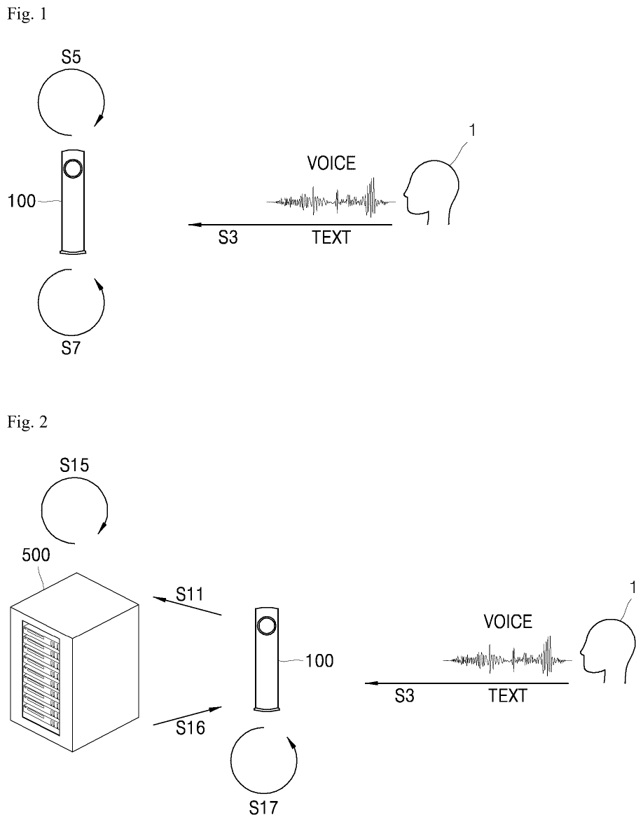

FIG. 1 is a view showing a process in which a home appliance operates upon receiving a command according to one embodiment of the present invention.

A user 1 inputs a predetermined command (e.g., voice or text) to a home appliance 100 (S3). The command can be input via voice or text. The home appliance (device) 100 performs speech-to-text on the input command (or input command) and determines a control command corresponding to the input command based on the preprocessed result (S5). When the control command is determined, the home appliance 100 executes the determined control command to perform a predetermined function (S7).

FIG. 2 is a view showing a process in which, upon receiving a command, a home appliance transmits the command to a server, receives a control command from the server, and then operates accordingly according to another embodiment of the present invention.

According to an embodiment, the home appliance 100 transmits the input command to a server 500 (S11). In this situation, when the input command is a voice command, the home appliance 100 can convert the voice command into text and transmit the command, which is the result of preprocessing the text, to the server 500.

In this situation, the server 500 can determine a control command corresponding to the received command (S15). The preprocessing process can be performed by the server 500. In this situation, the home appliance 100 can transmit the input command directly to the server 500.

When the control command is determined, the server 500 transmits information on the determined control command to the home appliance 100 (S16), and the home appliance 100 executes the received control command to perform a predetermined function (S17).

For example, a home appliance can send a user's command to a server, which then interprets the command to understand the user's intention and determines the specific action the appliance should perform. The appliance then executes this server-decided command, but embodiments are not limited thereto. According to another embodiment, the decision process for determining the user's intention and generating a corresponding control command can be performed locally by the home appliance 100.

As shown in FIGS. 1 and 2, the server 500 or the home appliance 100 can generate an appropriate control command for the preprocessed command.

Hereinafter, the description focuses on the server 500 performing tasks for command recognition, but the present invention is not limited thereto, and the home appliance 100 can also provide some or all of functions provided by the server 500. In addition, for convenience of description, an air conditioner will be described as an example of the home appliance 100, but the present invention is not limited thereto.

Hereinafter, a device for implementing embodiments of the present invention will be described.

The embodiments of the present invention can be implemented in various devices. The device includes various types of a server, a home appliance, an electronic device, a computing device, a television, a smart phone, etc. In addition, the device of the present invention can include hardware or software components that perform the embodiments of the present invention in addition to physical devices. In addition, the embodiments of the present invention include programs, hardware, chips, and the like stored in a form capable of executing predetermined tasks or implemented in a form capable of executing the task.

Programs, software, and the like can be fixedly stored within the device or can be temporarily transmitted from an external source, stored in the device, and then executed. In the situation of the fixed storage method, the device can include a non-transitory computer readable medium.

That is, the embodiments of the present invention can be implemented as one or more computer programs or computer-readable storage media in a combination of one or more of the above ones.

The functions of the elements disclosed herein can be implemented using circuits or processing circuits including general-purpose processors, special-purpose processors, integrated circuits, application-specific integrated circuits (ASIC), existing circuits, and/or a combination thereof. The circuits can be processors configured or programmed to perform the disclosed functions. The processor can include transistors and other circuits and thus can be considered a processing circuit or circuit.

The circuits, units, or means herein can be hardware that performs or is programmed to perform the functions described in the detailed description. The hardware can be the hardware disclosed herein or other known hardware and can be hardware that is programmed or configured to perform the functions described in the detailed description. When the hardware is a processor, which can be considered a type of circuit, the circuits, means, or units can be a combination of hardware and software and can be software used to configure the hardware and/or the processor. In addition, the computer storage medium can be a non-transitory computer readable medium. For example, the computer storage medium can be executable by a cloud server-based system. The computer storage medium can be disposed within a single device or distributed across two or more different devices. Accordingly, a single logical computer storage medium can physically include two or more computer storage media, and positions at which these media are disposed can also be one or more positions. The computer storage medium includes various storage media such as a hard disk, a CD/DVD disk, a memory card, a memory chip, etc.

In addition, the data described herein can be calculated or performed in various environments, such as a cloud server-based system, an on-device system, a distributed server system (multiple servers), etc. The data can be processed in a distributed manner in a cloud server or executed locally on an on-device processor, and the results of the processing in each environment can be stored in non-volatile memory.

Electronic devices, such as home appliances, and server computing devices can be connected to one or more storage devices via a network. The storage device can be a combination of volatile and non-volatile memories and may or may not be disposed at the same physical position as the computing device.

The server computing device can include one or more processors and a memory. In this situation, the memory can store information accessible to the processor and include data that can be processed, stored, or modified by processor-executable commands. In addition, the memory can include volatile and non-volatile memories. The processor can include a central processing unit (CPU), a graphics processing unit (GPU), a field programmable gate array (FPGA), an ASIC, or a tensor processing unit (TPU).

Instructions can be configured to perform specific operations when the processor executes an instructed task and stored in object code or an interpretable script format. These commands can be used to implement the system and executed on a local or remote processor. Data can be retrieved, stored, or modified in response to the commands and configured in a database, JSON, YAML, or XML format.

These commands can include executable files, source code files, metadata, etc.

Electronic devices including home appliances and hubs can be configured similar to a server computing device. The electronic devices including home appliances and hubs can include a processor, a memory, commands, data, and user input and output devices. The server computing device can transmit data to the electronic device, and the electronic device can display a portion of the received data through a display. In addition, data transmission and communication between the server computing device and the electronic device is possible via networks such as BLUETOOTH, Wi-Fi, wired and wireless networks, or the like, and direct and indirect communication between computing devices is possible, thereby supporting various protocols and connection methods.

In addition, the functions of the server computing device of the present invention can be performed by a smartphone, a tablet, etc.

The methods or processes in the embodiments of the present specification sequentially perform one or more tasks, and each task can be performed by either hardware or software or collaboration between the two. For example, hardware can perform a first task, and software can perform a second task. Of course, hardware can perform the entire task, or software can perform the entire task.

FIG. 3 is a view showing a configuration of the server according to one embodiment of the present invention.

The server 500 includes a server control unit 550 (e.g., controller, or processor), a control sample database 510, a situational sample database 520, a control command database 530, and a server communication unit 590 (e.g., transceiver, or communication interface). In addition, the server 500 includes a generative artificial intelligence (AI) module 300. That is, the generative AI module 300 can be implemented in the server 500 or an external device. The generative AI module 300 can be single software or hardware, or a computer-executable storage medium. In one embodiment of the electronic device, the server 500 or the home appliance 100 can process various information, perform communication, and process data stored in a storage medium such as a memory or the like. The server 500 or the home appliance 100 can include the generative AI module in the form of software, hardware, or a storage medium. Alternatively, the generative AI module can be implemented in the form of software, hardware, or a storage medium in an external device other than the server 500 or the home appliance 100. According to an embodiment, the generative AI module can include one or more large language models (LLMs) with an attention-based transformer architecture. Accordingly, the generative AI module 300 described herein can be implemented as a generative AI unit, a generative AI controller, a generative AI program, generative AI software, generative AI hardware, etc.

The server control unit 550 determines, for the input command, which category the input command belongs to or which control command the input command corresponds to and generates a corresponding control command. During the determination process, the server control unit 550 (e.g., controller) can input predetermined information into the generative AI module 300. That is, in order to identify a category, the server control unit 550 can input the input command to the generative AI module 300 and acquire a category as a result. This can also be applied to the device control unit 150 (e.g., controller, or processor in the device 100).

The databases 510 and 520 can store multiple sample texts. In addition, among the databases, a situational sample database 520 can store predefined routines or user schedules and preferences.

The server communication unit 590 communicates with the home appliance 100. In addition, when the generative AI module 300 is disposed in an external device (e.g., external server), the server communication unit 590 also communicates with the external device.

When the server communication unit 590 receives a command input into the home appliance 100 from the home appliance 100, the server control unit 550 determines whether the command input to the home appliance 100 corresponds to direct control. For example, according to an embodiment, direct control can refer to a command from a user that the system can immediately understand and execute without using interpretation from an artificial intelligence model. Further, a direct control command can be a command that is predefined and directly matches a specific function or feature set within the home appliance's or server's existing database. The system recognizes the command and can generate a corresponding control command with high accuracy without further analysis.

For example, if a user says, “Turn on the air conditioner,” and this command is a pre-programmed type of command, it can be considered direct control. The system does not need to infer the user's intent, it executes the “power on” function for the air conditioner.

Alternatively, non-direct control commands can be more ambiguous or creative, such as “I'm feeling very cold.” Such commands can use a generative AI module to interpret the user's intent and generate a specific command. For example, according to an embodiment, the method can include determining if an input command corresponds to this type of direct control. If it does not, the system can then employ a generative AI module for interpretation.

When the determination result indicates that the input command does not correspond to the direct control (e.g., a non-direct control command), the server control unit 550 extracts sample texts having similarity greater than or equal to a predetermined reference value with the input command from the database 520 and inputs the sample texts to the generative AI module 300. According to an embodiment, similar sample texts can be retrieved based on text matching or a text matching score. According to another embodiment, sample texts can be stored as embedding vectors, and similar sample texts can be retrieved based on a vector similarity function, such as cosine similarity or Euclidian distance.

For example, the server control unit 550 can input a guide including a category for the command together with the command and sample texts (sample texts having similarity greater than or equal to a predetermined reference value with the input command) extracted from a database to the generative AI module. In addition, a result generated by the generative AI module can include the category of the input command, and the server control unit 550 can generate a control command using the generated result. Such a process can also be performed in the device control unit 150 (e.g., controller, or processor in the device 100).

The similarity can be determined based on whether the input commands are the same type. For example, in the situation of an air conditioner, temperature control, wind direction control, time setting, and the like are each the types of commands. For a command related to the temperature control, the server control unit 550 can extract an existing sample text related to temperature from the database 520. According to an embodiment, such similarity determination can also be performed in the device control unit 150.

When the input command corresponds to the direct control, the server control unit 550 (e.g., controller) can generate a control command corresponding to the input command without inputting the input command to the generative AI module 300. The result generated by the generative AI module 300 can include a category of the input command (e.g., the input user command).

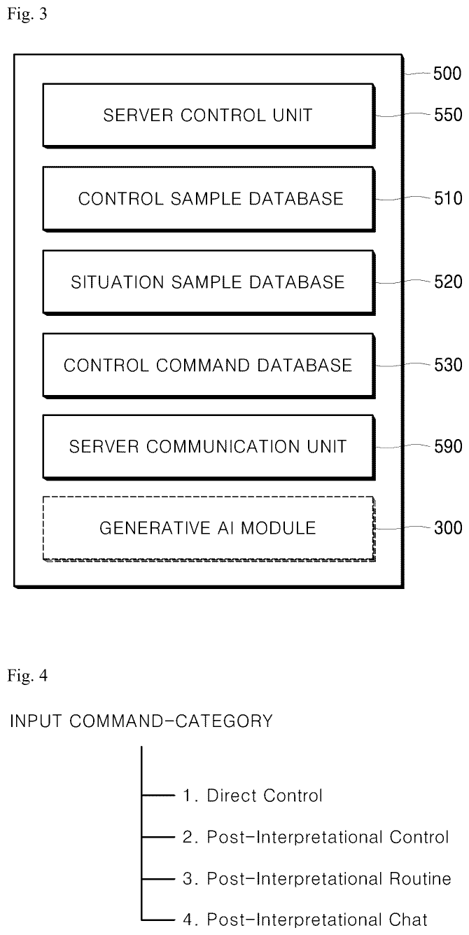

And, when the input command corresponds to post-interpretational control in the result generated by the generative AI module 300, the server control unit 550 generates a control command using the generated result. This refers to the category description of FIG. 4.

In addition, the server communication unit 590 transmits the control command to the home appliance 100 so that the home appliance 100 can provide functions in response to the generated control command, thereby enabling the server 500 to control the home appliance 100 in response to the command. For example, in the situation of a non-direct command, the generative AI module can interpret the user's command to understand the intent of the user, then server can create a corresponding direct control command based on the AI module's output. This new direct control command can then be sent to the home appliance, instructing it to perform the function that fulfills the user's original request and intent.

FIG. 4 is a view showing classification of input commands according to one embodiment of the present invention.

Hereinafter, an input voice commands, an input text command, or an utterance resulting from preprocessing thereof are collectively referred to as an input command.

The input commands generally belong to direct control (e.g., Category 1) or non-direct control (e.g., Categories 2, 3, and 4). That is, the input commands can be categorized into those requiring interpretation via the generative AI module (e.g., Categories 2, 3, and 4) and those not requiring interpretation (e.g., Category 1).

The direct control refers to a situation in which an input command directly matches a control command required to control a home appliance (e.g., a pre-defined instruction). This corresponds to a situation in which the server 500 does not apply a separate interpretation process to the input command. The input command corresponding to the direct control can correspond to one or more control commands.

When the input command belongs to the direct control category, the server 500 generates a control command necessary to control the home appliance 100 in response to the input command. For example, when the input command corresponds to a single control command (composed of a single utterance sentence), such as “Turn on the air conditioner” or “Temperature 25 degrees,” or when the input command corresponds to two control commands (composed of a composite utterance sentence), such as “Level 4 airflow in a cooling mode,” the server 500 can control the home appliance 100 using the corresponding control command. That is, the server 500 can generate a control command based on the input command (input command) corresponding to the direct control and provide the control command to the home appliance 100.

The server 500 can determine whether the input command corresponds to the direct control, and when the input command does not correspond to the direct control, the server 500 inputs the control command to the generative AI module 300. In this situation, the server 500 can include a base, a guide, and a sample text in the information (prompt) which will be input to the generative AI module 300.

The base includes information indicating the role the generative AI module 300 should perform or the result the generative AI module 300 should generate in order to interpret the input command. For example, the base can refer to a foundational set of instructions that is provided to the generative AI module (e.g., the base can also be referred to as the system prompt). The function of the base can be to define the operational context for the AI model, which can guide its interpretation of a user's command (e.g., type of appliance, description of results, constraints on results, etc.). This can include establishing the specific role the AI should perform, such as acting as an expert system for controlling home appliances. Additionally, the base can specify the required structure and format for the AI model's output.

The guide includes information for distinguishing which category the input command belongs to (i.e., which of categories 2, 3, or 4 in FIG. 4 it belongs to) and components of the control command the generative AI module 300 should generate corresponding to the information. For example, the guide can be a part of the prompt that provides specific, contextual information to the generative AI module for the command being processed. Unlike the base which can set the general operational parameters, the guide can supply task relevant details, such as a predefined category associated with the likely intent of the user's command (e.g., interpretational control, interpretational routine, or interpretational chat). The guide can constrain the AI module's interpretation to a specific functional domain, which can help reduce ambiguity and prevent the generation of irrelevant or incorrect responses. By focusing the AI model on a particular category, the guide can improve the accuracy and relevance of the final control command generated for the home appliance.

The prompt can also include a one shot example or few shot examples. For example, the sample text part of the prompt can be a dynamic component of the prompt that provides the generative AI module with concrete examples of previously interpreted commands. These examples can be selected from a database and can be chosen based on their high semantic similarity to the user's current input command. The sample text can offer the AI module a contextual model of a successful interpretation, e.g., demonstrating how similar phrases or intents have been translated into structured commands in the past. By providing these relevant examples, the AI model can better understand nuances and handle variations in user phrasing to generate a more accurate and reliable control command for the home appliance. For example, the sample text can be a sample sentence whose similarity to the input command is a predetermined reference value or more. The server 500 can extract N sample texts (N is a natural number greater than or equal to 1) from the database 510 or 520 that have similarity greater than or equal to the predetermined reference value with the input command using a BM25, cosine similarity technique, or Euclidean distance. That is, the sample texts can be sample sentences that have similarity greater than or equal to the predetermined reference value with the input command based on the BM25 or cosine similarity among the sample texts stored in the databases 510 and 520. In addition to the above method, there are various ways to extract example sentences.

A process of generating similarity according to one embodiment of the present invention is as follows. In order to generate similarity, user input commands can be preprocessed. For example, the server control unit 550 or the device control unit 150 can truncate the user input commands based on words or spaces, or extract nouns, foreign words, verbs, and root words through morphological analysis.

The server control unit 550 or the device control unit 150 can compare the preprocessed user commands with the sample texts stored in the database 520 to perform a primary filtering operation (e.g., 30, 40, etc.). During this process, the server control unit 550 or the device control unit 150 can re-sort the filtered results according to BM25 based on frequency or the like by applying cosine similarity.

Then, the server control unit 550 or the device control unit 150 can select i samples of the intent with the highest similarity score and j samples of the next-highest intent as samples.

The generative AI module 300 can generate a predetermined result in response to a prompt input to the generative AI module 300, and the server 500 determines that the input command corresponds to one of Categories 2/3/4 through the generated result.

When the input command belongs to post-interpretational control (Category 2), the server 500 can use the generated result to generate a control command necessary to control the home appliance.

Meanwhile, when the input command is a post-interpretational routine (Category 3), the server 500 can generate a control command corresponding to the corresponding routine. In this situation, the routine can be stored in the situational sample database 520 and can include common routines applicable in common to all home appliances and personalized routines applicable to home appliances used by specific users.

When the input command is a post-interpretational chat (Category 4), the server 500 outputs the generated result as voice or text. In order to enable the home appliance to output the generated result, the server 500 can generate a control command to allow a speaker or screen of the home appliance to output voice or text.

Categories 1, 2, and 3 all control the home appliance to perform specific operations. Accordingly, the input commands corresponding to Categories 1, 2, and 3 are control utterance commands. However, there are situations in which the user explicitly or implicitly provides instructions to operate the home appliance, and when the server 500 cannot generate a control command matching the input command (e.g., when the user input corresponds to a non-direct control command), the input command, base, guide, and sample texts can be input to the generative AI module 300 to determine the user intent and generate a corresponding command.

That is, even when the user explicitly instructs a functional operation, when the input command includes words or sentences unrelated to control or includes sentences with errors, the server 500 may not be able to generate a corresponding control command without further intention determination.

In this situation, the server 500 can increase the accuracy of command processing using the generative AI module 300 to determine the user's intent.

When the user implicitly inputs a voice/text command to operate the home appliance, the server 500 can process the voice/text command as a situation-related command. The situation-related commands can be classified into those defined/stored in the server 500 and those undefined.

That is, the server 500 can store routines, which are a set of functions provided by the home appliance 100, and even when the user instructs the execution of such routines, when the user cannot clearly utter the name of the routine, the accuracy of command processing can be increased using the generative AI module 300.

In addition, the server 500 can interpret the user intent even when the user intent is not specified in the routine.

In the present specification, when the home appliance or the server preprocesses the command input through the home appliance and the preprocessed command provides information necessary for controlling the home appliance (e.g., a direct control command), the appliance performs a process corresponding to the input command (e.g., Category 1). On the other hand, when the preprocessed command cannot provide the information necessary for controlling the home appliance (e.g., a non-direct control command), the home appliance performs a process in which the interpretation process for the input command is performed and the home appliance operates using the generated information after interpretation (e.g., Categories 2, 3, 4).

In order to enable the generative AI module 300 to generate the accurate result, the server 500 can extract sample texts with similarity greater than or equal to the predetermined reference value with the input command from the control sample database 510 or the situational sample database 520 and input the sample texts together with the input command to the generative AI module 300.

Consequently, the generative AI module 300 interprets the input command using the samples and generates the result includes information needed to generate control commands that allow home appliances to operate based on the input commands (e.g., the input user command accordingly. The server 500 generates a control command corresponding to the generated result and provides the control command to the home appliance 100.

The server 500 of the present invention can analyze and extract the user intent when receiving the voice/text command for the home appliance 100, such as an air conditioner or the like, and control the home appliance 100 in response to the user intent.

When a sentence spoken by the user (input command) corresponds to the previously set format (e.g., a direct control command), the server 500 can control the home appliance 100 in response to the input command without using a separate generative AI module 300.

Meanwhile, when the input command differs from the format set in the server 500 (e.g., a non-direct control command), the generative AI module 300 is used to interpret the input command and secure the corresponding result, and errors of the generative AI module 300 can be prevented by providing intent/control for the corresponding result as predefined information (base, guide, or the like).

In addition, the home appliance can be controlled in a customized manner using the personalized information of the user with respect to commands that are routine and commands that are not routine.

During voice command processing, the server 500 can select similar commands as sample texts and provides the sample texts to the generative AI module 300, thereby increasing the accuracy of the result, and the routine and non-routine types are applied to the output of the generative AI module 300, thereby sufficiently reflecting the user intent. According to an embodiment, the generative AI module 300 can be LLM-agnostic, such as ChatGPT, but embodiments are not limited thereto. For example, according to another embodiment, the generative AI module 300 can be based on a propriety LLM model that is trained or fine turned for the specific task of controlling home appliances.

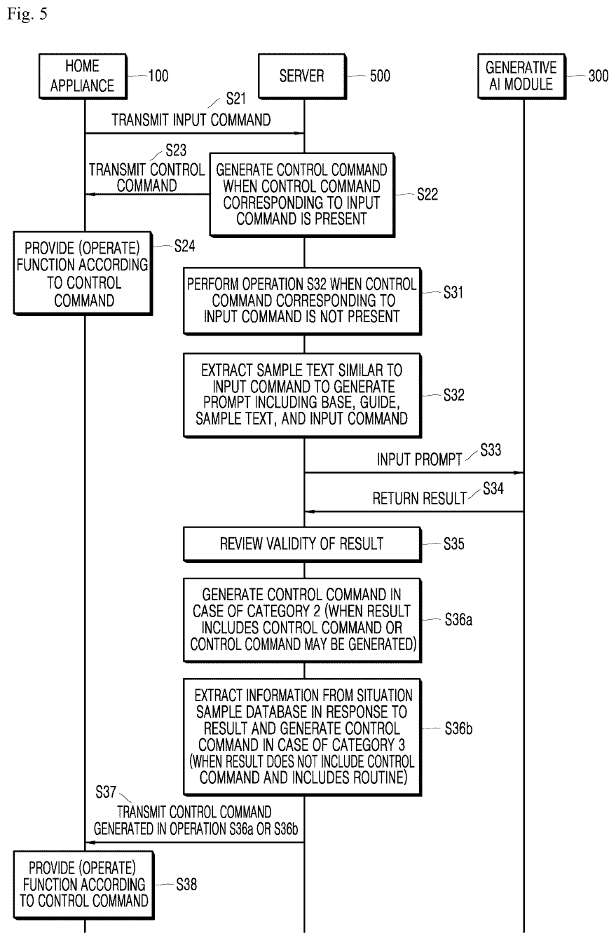

FIG. 5 is a view showing a process in which the server processes the input commands according to one embodiment of the present invention.

The home appliance 100 or a user terminal or remote controller linked to the home appliance 100 receives commands via voice or text. The home appliance 100 or user terminal transmits the input command (input command) to the server 500 (S21).

The server 500 determines whether the control command corresponding to the input command is present (e.g., wherein a direct command is present), and when the corresponding control command is present, the server 500 generates a control command (S22) and transmits the control command to the home appliance 100 (S23). Consequently, the home appliance 100 operates in response to the control command (S24).

On the other hand, when the control command corresponding to the input command is not present (S31) (e.g., a non-direct command), the server 500 extracts sample texts similar to the input command from the database and generates a prompt including the base, guide, sample texts, and the input command (S32). For example, sample texts are stored in the control sample database 510 or the situational sample database 520, and the server 500 can extract sample texts from the database 510 or 520 whose similarity to the input command is the predetermined reference value or more.

The server 500 can generate a prompt including the base, guide, sample texts, and input commands described above. A configuration of the prompt will be described below. Also, the generative AI module 300 can generate the prompt according to an embodiment.

In addition, the server 500 inputs the prompt to the generative AI module 300 (S33). When the generative AI module 300 is implemented in an external server, which is a generative AI service provider, the server 500 can input the prompt to the generative AI module 300 via an API predetermined with the generative AI service provider. An example in which the generative AI module 300 is implemented in the generative AI service provider can include generative AI models such as ChatGPT and various large-scale language models. Alternatively, the generative AI module such as ChatGPT can be disposed within the server 500.

In response to the prompt input in an operation S33, the generative AI module 300 generates and provides a result. That is, the generative AI module 300 returns the result in response to the prompt input in an operation S33 (S34).

The generative AI module 300 can be implemented in the server 500 or a separate external server (e.g., generative AI service provider). The server 500 can include guidance in the prompt in order to interpret which category the input command belongs to.

The server 500 reviews the validity of the result (S35). When the review result indicates that the result includes a control command or the control command can be generated, that is, when the result is Category 2, the server 500 generates a control command (S36a).

Meanwhile, when the review result indicates that the result does not include the control command but does include a routine, that is, when the result is Category 3, the server 500 extracts information from the situational sample database 520 in response to the result to generate the control command (S36b).

The server 500 transmits the control command generated in an operation S36a or S36b to the home appliance 100 (S37). Consequently, the home appliance 100 operates in response to the control command (S38).

The functions of the server 500 of FIG. 5 can be provided by the home appliance 100, according to an embodiment.

The process of FIG. 5 is briefly summarized as follows. The server 500 or the home appliance 100 determines whether the input command corresponds to a direct control command (S22, S31).

When the command input in an operation S22 or S31 does not belong to the direct control (Category 1), such as when the command input corresponds to a non-direct control command then the server 500 or the home appliance 100 extracts sample texts with similarity greater than or equal to the predetermined reference value with the input command from the database 510 or 520 and inputs the sample texts to the generative AI module 300 (S32, S33).

When the input command belongs to the post-interpretational control (Category 2) in the result (S34) generated by the generative AI module 300, the server 500 or the home appliance 100 generates a control command using the generated result (S35a). In addition, the home appliance 100 provides (operates) a function according to the generated control command (S37, S38).

When the input command corresponds to the direct control (Category 1) as in the operation S22, the server 500 or the home appliance 100 generates a control command corresponding to the input command, and the home appliance 100 provides a function according to the control command corresponding to the input command (S23).

When the input command does not correspond to Category 1 in the operation S32, the server 500 or the home appliance 100 can input sample texts and the input command to the generative AI module 300. In this situation, the server 500 or the home appliance 100 can extract sample texts having similarity greater than or equal to the reference value with the input command from the databases 510 or 520 and input the sample texts to the generative AI module 300. The sample texts refer to Tables 3 to 7, which will be described below.

In addition, when the input command belongs to Category 3, that is, corresponds to the execution of the routine stored in the server 500 or the home appliance 100 as shown in Table 6 below, the server 500 or the home appliance 100 acquires a control command corresponding to the stored routine and controls the home appliance 100 accordingly.

That is, when the input command corresponds to the post-interpretational routine (Category 3) in the result generated by the generative AI module 300, the server 500 or the home appliance 100 can generate a control command corresponding to the routine included in the generated result. To this end, the server 500 or the home appliance 100 can extract a control command corresponding to a pre-stored routine from a memory, a database, etc.

The server 500 or the home appliance 100 of the present invention can implement a GPT prompt to improve voice recognition to enable the server 500 or the home appliance 100 to interpret the utterance text even when the user inputs a command including a control function or sentences (e.g., non-control utterance) related to a specific situation. In addition, by using representative utterance learning data and a sample extraction algorithm, which are an example of sample texts, the server 500 or the home appliance 100 can interpret the intent of the input command (or sentence) of the user and recommend appropriate functions.

In particular, by interpreting the command input by the user using the generative AI module 300, the user intent to control the home appliance can be extracted even from complex utterances without a predefined format. In addition, the user can provide voice commands relevant to his or her situation to enable the home appliance to perform customized operations according to the user's situation. In addition, when a specific routine operation is set for the home appliance, the server 500 or the home appliance 100 can load a control command related to the routine corresponding to a sentence including the user's situation and use the control command to control the operation of the home appliance 100.

According to an embodiment of the present invention, when a user-uttered or text-input sentence directly corresponds to a control command for controlling a home appliance, the home appliance is controlled based on the corresponding control command (e.g., a direct control command), and otherwise in the situation of a non-direct control command, the home appliance is controlled based on the result interpreted by the generative AI module 300. Consequently, first, since the server or the home appliance can quickly determine whether the user's command corresponds to the direct control (Category 1) of FIG. 4, the voice/text control of the home appliance can be quickly performed.

In addition, when the user's command does not correspond to the direct control (Category 1), the server or the home appliance collaborates with the generative AI module 300 to acquire the control command corresponding to the input command, enabling accurate voice/text control of the home appliance.

Using the generative AI module 300, the server 500 or the home appliance 100 can process both utterances including control functions and non-control utterances.

For the utterances including control functions, complex utterance sentences indicating various control commands, sentences including non-control words, short utterances including errors or mispronunciations during recognition, and the like can be processed (see Tables 3 to 5).

In addition, for situation recognition utterances, the generative AI module 300 can provide a description or an interpretation result of the situation in a predefined situation (a set routine), a ThinQ routine, or an undefined situation. In addition, utterances related to everyday chat can also be processed by the server 500 or the home appliance (see Table 6 or 7).

That is, by dividing control commands to control the home appliance into intent control commands and slot control commands, the server 500 or the home appliance 100 can flexibly process user-input sentence-type commands to extract a device control intent of the user even from complex utterance commands and control the functions of the home appliance 100. The intent control commands and the slot control commands will be described below.

In addition, by inputting sample texts and guides for undefined routines or situations to the generative AI module 300, the server 500 or the home appliance 100 can combine two to three control commands for functions that the home appliance (e.g., an air conditioner) can provide.

By interpreting the user's utterance, a predefined routine (e.g., a routine stored in a ThinQ server or app) can be executed.

The control command to control the home appliance 100 controls the operation of the home appliance, that is, the home appliance to provide a specific function. The control commands of the home appliance are divided into the intent control commands and the slot control commands.

The intent control command can indicate a high-level concept of the function of the home appliance 100, and the slot control command can indicate a more detailed function of the intent control command. For the home appliance to operate, both the intent control commands and the slot control commands should be provided. That is, the set of the intent control commands and the slot control commands dictates the functions to be performed by the home appliance.

That is, the intent control command is a high-level concept of control command, such as on/off, temperature control, and airflow control, among the functions of the home appliance functions. The slot control command corresponds to detailed settings of these intent control commands, and a specific control command for on/off includes on (turn-on) and off (turn-off), and the slot control command constituting the intent control command for temperature control can be specific temperature values. The home appliance performs its functions through a set of the intent control commands and the slot control commands.

For example, a slot control command can be a structured, machine-readable instruction generated as a final output of the interpretation process. The slot control command can be organized such that each “slot” represents a specific parameter for execution, such as the target device, the action to be performed, or a particular setting value. For example, the natural language input “it's too dim in the kitchen” can be translated into a slot control command such as {device: “kitchen_light”, action: “set_brightness”, value: “80%”}. This format can eliminate the ambiguity inherent in human speech to provide the home appliance with a precise command that can be executed directly without further interpretation.

In addition, an intent control command can represent a higher-level, conceptual goal derived from the user's natural language input, which can encompass multiple actions or a more abstract objective. Unlike a slot control command that can specify a precise operation, an intent control command can identify the user's overall purpose, such as “prepare for movie night” or “increase home security.”

For example, the method can first identify the intent from the user's speech. Then, the identified intent can be used to generate one or more specific slot control commands to fulfill the user's goal. For example, the intent “movie_night” could trigger the generation of separate slot control commands to dim the lights, turn on the television, and adjust the sound system. Thus, translating a single abstract goal into a sequence of concrete, executable actions.

For an air conditioner, some of the intent control commands and slot control commands are listed in Table 1, below. The appliance can be turned on in response to the intent control command AIR_POWER_REQUEST and the slot control command ON.

TABLE 1

| Intent control commands | Slot control commands |
|---|---|
| Power on-off (AIR_POWER_REQUEST) | On or off |
| Temperature control | 15 to 30 |
| (AIR_TEMPERATURE_REQUEST) | |
| Time control (AIR_TIME_REQUEST) | 10 minutes to 3 hours |
| Airflow level/air speed control | 1 to 5 |
| (AIR_WIND_STRENGTH_REQUEST) | |
| Wind Direction Control(AIR_WIND_{—} | left/right/up/down |
| DIRECTION_REQUEST) | |
| Function (AIR_OPERATION_REQUEST) | Cooling/Blow/ |
| | Dehumidification/Sleep |
| Wind characteristics setting | Indirect wind |
| (AIR_WIND_SETTING_REQUEST) | |

For an oven, some of the intent control commands and the slot control commands are listed in Table 2, below.

TABLE 2

| Intent control commands | Slot control commands |
|---|---|
| On_off(OVN_POWER_REQUEST) | On or off |
| Temperature control | 180 to 250 |
| (OVN_TEMPERATURE_REQUEST) | |
| Time control (OVN_TIME_REQUEST) | 10 minutes to 1 hours |
| Function (OVN_OPERATION_{—} | Heating/Cooking/ |
| REQUEST) | Defrosting |

That is, the intent control commands correspond to the user intent to control the device, and the slot control commands are details of such an intention. Accordingly, when the intent control commands and the slot control commands are combined, the home appliance can operate with a specific function. Depending on the home appliance, when the contents of Table 1 or 2 are input to the generative AI module 300, the generative AI module 300 can generate the intent control commands and the slot control commands corresponding to the input commands.

In addition, the generative AI module 300 can interpret which intent the voice/text command input by the user has.

In addition, sample texts can be input to the generative AI module 300 so that the generative AI module 300 can generate the intent control commands and slot control commands corresponding to the input commands.

In order to obtain accurate results through the generative AI module 300, a prompt can be generated.

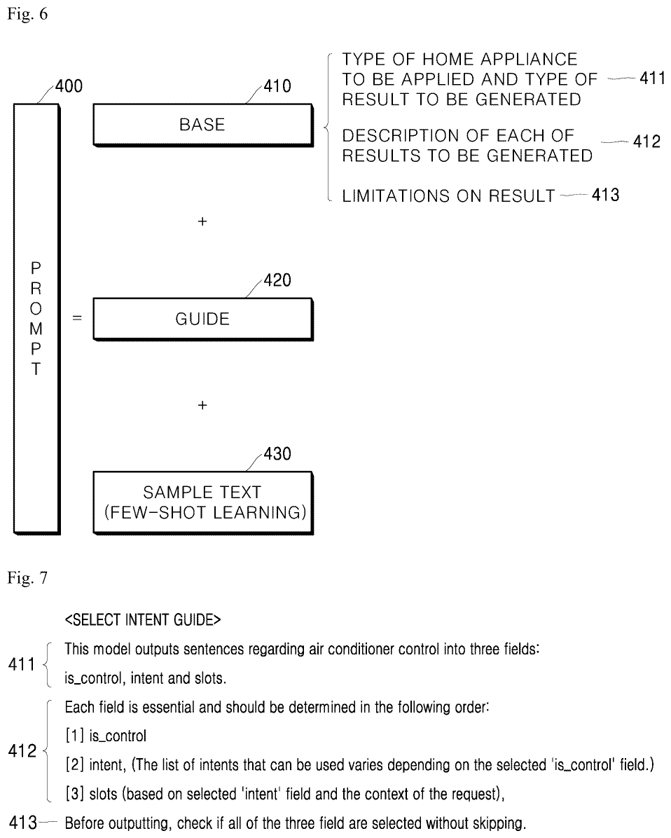

FIG. 6 is a view showing a structure of a prompt according to one embodiment of the present invention. The name of the information to be input to the generative AI module 300 is referred to as a prompt, but the present invention is not limited thereto. The server 500 or the home appliance 100 can extract intent control commands (Intent) and slot control commands (Slot) from the input commands by inputting text classification and few-shot learning based on prompting using a generative pre-trained transformer large language model (GPT LLM) in order to acquire information from the generative AI module 300.

A prompt 400 can be composed of a base, a guide, sample texts, and input commands for controlling the home appliance as described above, and all or only some of these can be included according to embodiments.

The base 410 includes information indicating the role the generative AI module 300 should perform or the result the generative AI module 300 should generate in order to interpret the input command. For example, the server 500 or the home appliance 100 can generate the base as follows. The base can include basic rules, specifically the types of home appliances to be applied, the types of results to be generated 411, descriptions of each result 412, and limitations on the results 413.

The generative AI module 300 is instructed to generate results in the order of [1], [2], and [3] by specifying three fields for the results to be generated. See FIG. 7.

The guide includes information for distinguishing which category the input command belongs to (e.g., which of categories 2, 3, or 4 in FIG. 4 it belongs to) and components of the control command the generative AI module 300 should generate corresponding to the information. In one embodiment, the guide includes a text classification method and the definitions of intents/slots. The guide can include descriptions or definitions of the intent control commands and the slot control commands. The guide 420 can be written in various ways according to the characteristics or implementation method of the generative AI module 300.

FIG. 7 is a view showing an example description of a base according to one embodiment of the present invention. Each corresponding element is indicated by a reference numeral. 411 indicates the type of result to be generated and that the applicable device is an air conditioner. 412 defines three control-related results (whether a control command is present, an intent, and a slot). 413 indicates that three items should be included in the output.

For example, the guide can describe the rules for each result, list the intent control commands and slot control commands that should to be filled in, and specify which rules to be followed when filling in the content.

The guide can be composed of three areas. The three areas are, for example, a guide for outputs, a guide for outputs of the intent control commands, and a guide for outputs of the slot control commands.

The guide for outputs instructs whether an input command is for control. For air conditioner-related home appliances, weather, situations, and emotions belong to “non-control,” and power, temperature settings, wind speed, and the like, which are related to air conditioner control, belong to “control.”

The intent control commands and their descriptions shown in Table 1 are composed of a single set. The intent control commands, as a high-level concept of slots, can instruct the selection of one specific category for the input command.

An area that guides information on the slot control commands can instruct that different intent control commands be processed separately. When the output is “control,” slot control commands related to air conditioner control can be listed. These can be individually guided in response to the intent control commands.

Intent control commands-slot control command 1, slot control command 2, etc.

The guide and sample text (Few-Shot Learning) can be input to the LLM. The sample text 430 is a sample sentence with similarity greater than or equal to the predetermined reference value with the input command, and the server 500 can extract N sample sentences (N is a natural number greater than or equal to 1) with similarity greater than or equal to the predetermined reference value with the input command from the database 510 or 520 using the BM25 or cosine similarity technique.

The sample texts that serve as learning data are various utterances (representative utterances), which can be stored in the control sample database 510 or the situational sample database 520.

The sample texts stored in the control sample database 510 and the corresponding intent control commands and slot control commands are shown in the following tables. Table 3 shows complex utterance sample texts with two or more controlling functions (intent control commands). Table 4 shows sample texts including words or sentences unrelated to control. Table 5 shows sample texts including some errors.

TABLE 3

| Sample texts | | |
|---|---|---|
| (Uttered sentences) | INTENT | SLOT |
| Lower temperature to | AIR_TEMPERATURE_REQUEST | [{‘temperature’: ‘26’}] |
| 26 degrees and increase | AIR_WIND_STRENGTH_REQUEST | [{‘wind_speed’: ‘up’}, |
| a wind speed by 2 levels | | {‘option’: ‘2’}] |
| Operation in cooling | AIR_OPERATION_REQUEST | [{‘mode_name’: ‘cool’}, |
| mode at airflow level 4 | | {‘onoff’: ‘on’}] |
| | AIR_WIND_STRENGTH_REQUEST | [{‘wind_speed’: ‘4’}] |

TABLE 4

| Sample texts | | |
|---|---|---|
| (Uttered sentences) | INTENT | SLOT |
| Turn on the air | AIR_POWER_REQUEST | [{‘onoff’: ‘on’}] |
| conditioner, it feels | AIR_OPERATION_REQUEST | [{‘mode_name’: ‘cool’}, |
| suffocating, and cool | | {‘onoff’: ‘on’}] |
| the room. | | |
| Set the temperature to | AIR_TEMPERATURE_REQUEST | [{‘temperature’: ‘26’}] |
| 26 degrees | | |

TABLE 5

| Uttered sentences | INTENT | SLOT |
|---|---|---|
| Se-------t to 24 degrees | AIR_TEMPERATURE_REQUEST | [{‘temperature’: ‘24’}] |
| Set the wind speed to | AIR_WIND_STRENGTH_REQUEST | [{‘wind_speed’: ‘1’}] |
| Level 1 | | |
| Set the target temperature | AIR_TEMPERATURE_REQUEST | [{‘temperature’: ‘22’}] |
| to 22 degrees | | |
| Turn on the air cleaning | AIR_OPERATION_REQUEST | [{‘mode name’: ‘airclean’} |
| mode | | {‘onoff’: ‘on’}] |

When the sample texts shown in Tables 3 to 5 are input, and the base and the guide are input, the generative AI module 100 generates the result including the intent control command and the slot control command.

For example, when the user inputs a command “Set the temperature to 23 degrees and increase airflow,” the generative AI module 100 can generate the following result based on the sample texts shown in Table 3.
[{“intent”:“AIR_TEMPERATURE_REQUEST”,“slots”:[{“temperature”:“23”}]}]
[{“intent”:“AIR_WIND_STRENGTH_REQUEST”,“slots”:[{‘wind_speed’: ‘up’}]}]

Meanwhile, sample texts that instruct routines related to specific situations can be classified into two types, for example, predefined routines and non-predefined routines.

The predefined routines are predefined situations corresponding to home appliances, such as exercising, studying, getting a job, going out, or the like, and users can instruct these routines. Table 6 shows sample texts related to routines.

TABLE 6

| Situations | Sample texts | Customized operation (example) | |
|---|---|---|---|
| Exercise | “I'm going to | Direct airflow On | [{“intent”: |
| | exercise at home.” | Desired | “AIR_EXERCISE_REQUEST”, |
| | “I'll do home- | temperature: 22 | “slots”:[{“wind_setting”: |
| | workout” | degrees | “direct”} |
| | “My body is sore, so | | {“temperature”: “22”}]}] |
| | I'm going to | | |
| | exercise.” | | |
| Study | “Help me focus on | Low-noise mode | [{“intent”: |
| | my studies.” | Indirect airflow On | “AIR_STUDY_REQUEST,” |
| | “I'm going to study | | “slots”:[{“wind_setting”: |
| | hard from now on.” | | “indirect”}, |
| | “I'm going to study, | | {“additional_one”: |
| | so help me focus.” | | “low_noise”}]}] |
| Sleep | “I'm slowly getting | Mood light Off | [{“intent”: |
| | sleepy. I'm going to | Sleep timer | “AIR_SLEEP_REQUEST”, |
| | sleep now.” | | “slots”:[{“additional_two”: |
| | I'm tired and going | | “light_off”}, |
| | to sleep, make it | | {“sleep_reservation”: “6”}]}] |
| | comfortable for | | |
| | sleeping.” | | |
| | “I'm sleepy.” | | |
| Server | “Activate the | Server acquires specific routine operation. | |
| selection | “Leaving Home” | | |
| Routine | routine.” | | |

Next, for the unspecified routine, the generative AI module 300 can output corresponding information.

TABLE 7

| Sample texts | Customized operation (example) | |
|---|---|---|
| “Keep the temperature and | Cooling Desired | [{“intent”:“AIR_GPT_RECOMMEND,” |
| humidity at a comfortable | temperature: 24 degrees | “slots”:[{“mode_name”:“cool”}, |
| level for the cat.” | Wind speed: low | {“temperature”:“24”}, |
| | | {“wind_speed”:“low”}] |
| “I feel suffocated | Cooling | [{“intent”:“AIR_GPT_RECOMMEND,” |
| at home since it's | Direct airflow On | “slots”:[{‘mode_name’: ‘cool’}, |
| so crowded.” | Wind speed: high | {‘wind_setting’: ‘direct’ |
| | | {‘wind_speed’: ‘high’}]}]’}, |

Next, when the input command is completely unrelated to controlling the home appliance, the input command corresponds to “post-interpretational chat” (Category 4), and thus the generative AI module 300 can output a corresponding result. When the user inputs the command “Who is the author who won this year's Nobel Prize in Physics?,” the generative AI module 300 can output the following result.
[{‘intent’: ‘CHAT_REQUEST,’ ‘slots:’ [{‘answer’: ‘The person who won the Nobel Prize in Physics this time is A’}]}]

That is, when the result generated by the generative AI module 300 in response to the input command corresponds to the post-interpretational chat, the server 500 or the home appliance 100 generates a control command that outputs the generated result via voice or text. Then, the home appliance 100 can output a portion of the generated result via voice or text.

In this situation, the user can communicate with the home appliance 100 by asking questions and receiving answers.

As shown in Tables 3 to 7, the sample texts stored in the databases 510 and 520 can include sentences for controlling the home appliance and a set of corresponding intent control commands and slot control commands.

Among these, Tables 3 to 5 can be stored in the control sample database 510, and Tables 6 and 7 can be stored in the situational sample database 520.

Alternatively, the sample texts in Tables 3 to 7 and the corresponding sets of the intent control commands and the slot control commands can be stored in a single database without distinction.

Using various sample texts and routines stored in the server, the server 500 can generate control commands appropriate to the user intent. The user can instruct the home appliance to perform a specific function using a voice or text command, but these commands may not directly match the control commands that control the home appliance 100.

Direct matching corresponds to the direct control of FIG. 4 (e.g., direct control command). For example, in order to start the operation of an air conditioner on, the user can input a command including expressions such as “turn on/turn on/switch on/please, switch on/start/please start.” However, the user can input commands, which include other expressions and start the operation of the air conditioner, to the home appliance.

For example, when the user inputs “Air conditioner, it's hot,” the input command does not include various verbs described above, such as “turn on/please, turn on/switch on/please, switch on/start/please, start,” and thus does not instruct a specific function of the air conditioner (e.g., a non-direct control command). However, since the user intent is to turn on the air conditioner or increase the airflow, the user intent instructs the operation of the air conditioner.

The server 500 inputs sample texts to the generative AI module 300 so that the generative AI module 300 can interpret commands even when the commands do not correspond to the direct control. That is, the generative AI module 300, which receives the sample texts corresponding to the intent control commands and the slot control commands that indicate the functions provided by the home appliance, can also generate intent control commands and slot control commands for the input commands.

In addition, a home appliance can operate according to various routines, and an air conditioner can include, for example, a study routine, an exercise routine, and the like, and a wind speed, an airflow, a target temperature, and the like can be set according to the corresponding routines. Similarly, an oven can have routines for reheating instant rice and boiling ramen, and heating temperatures, times, and the like can be set according to the corresponding routines.

Even when the command input by the user does not exactly correspond to a routine, when the server 500 inputs a situational sample texts to the generative AI module 300, the generative AI module 300 can generate a result by reflecting the situational sample texts, and when the generated result corresponds to a specific routine, the server 500 can generate a control command based on the corresponding routine.

That is, the server 500 extracts sample utterances with similarity greater than or equal to the predetermined reference value with the input command from the situational utterance database 510 and inputs the sample utterances to the generative AI module 300 together with the input command. Consequently, the generative AI module 300 interprets the input command using the sample utterance and generates a result accordingly. The server 500 generates a control command corresponding to the routine instructed by the generated result and provides the control command to the home appliance 100.

When the input command does not correspond to a predefined routine, the server 500 guides the generative AI module 300 to generate a result related to the undefined routine, thereby enabling the generative AI module 300 to generate the result accordingly.

The server 500 according to the embodiment of the present invention can provide an AI service and include the databases 510 and 520 that stores past personalized or routinized information on the customer.

Based on learning about the user's lifestyle, an optimized space solution can be provided to each individual. For example, when the user uses a voice or text command, such as “I studied well last week. Set it up the same way,” the settings stored in the databases 510 and 520 at that time can be loaded to establish a personalized environment.

In one embodiment of the present invention, the server 500 includes a server cluster, which is a set of various servers. Accordingly, the configuration of the server 500 can be easily changed by those skilled in the art.

FIG. 8 is a view showing a flow for interpreting the input commands using a generative AI module according to one embodiment of the present invention. FIG. 8 shows a detailed embodiment of the embodiment of FIG. 5.

When a command is input to the home appliance 100, the server 500 receives the command (S21). In addition, the server 500 determines whether a control command corresponds to the command (S31, S32), and then otherwise, generates a prompt and inputs the prompt to the generative AI module 300 (S33). After the server 500, which receives the result generated by the generative AI module 300 (S34), reviews the validity of the result, performs an operation S36a or S36b depending on the type of the result, and transmits the control command to the home appliance 100, the home appliance 100 provides (operates) a function according to the control command (S38).

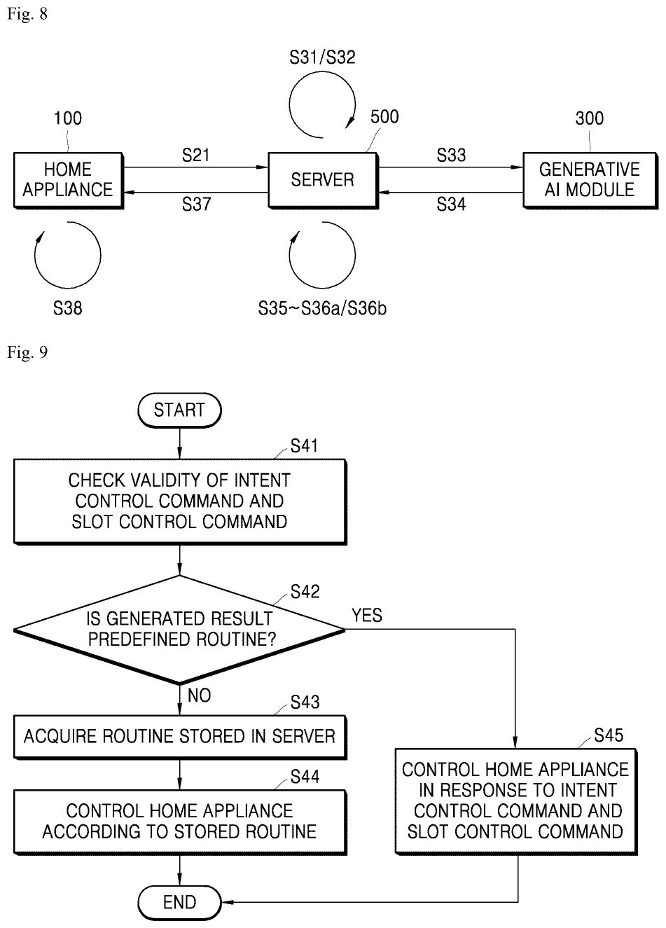

FIG. 9 is a view showing a detailed operation process of the server according to one embodiment of the present invention. An operation S35 will be described in detail.

The server control unit 550 of the server 500 checks whether the intent control command and slot control command included in the result generated by the generative AI module 300 are valid (S41). This can be checked using the intent control command and a corresponding slot control command as shown in Table 1 or 2. For example, the server control unit 550 determines that the result is valid when the intent control command generated in relation to the air conditioner is AIR_POWER_REQUEST and the slot control command is “ON.”

On the other hand, when the intent control command generated in relation to the air conditioner is AIR_POWER_REQUEST and the slot control command is “5 minutes,” the generated result is incorrect, and thus the server control unit 550 can instruct the home appliance 100 to re-input the command.

Alternatively, the server control unit 550 can determine whether the generated result indicates a routine, and when the generated result indicates the routine, the server control unit 550 can determine whether the routine corresponds to a stored routine to perform a validity check.

After completing the validity check in an operation S41, the server control unit 550 determines whether the generated result corresponds to a predefined routine (S42). When the generated result corresponds to the predefined routine, the server control unit 550 acquires the routine stored in the database (S43) and controls the home appliance 100 according to the stored routine.

Meanwhile, when the generated result is not the predefined routine, the server control unit 550 generates a control command based on the intent control command and the slot control command and transmits the control command to the home appliance 100 to control the home appliance 100 (S45).

The user input command (voice, text) is subjected to a predetermined preprocessing process in the server 500 or the home appliance 100. When the input command corresponds directly to a word or sentence defined and stored in advance to control the home appliance (e.g., a direct control command), the server 500 or the home appliance 100 converts the input command into a control command, such as without further interpretation by the AI model.

Meanwhile, when interpretation of the input command is required (e.g., a non-direct control command), the server 500 or the home appliance 100 performs a command interpretation process using the AI model. During this process, a generative AI can be used, and the server 500 or the home appliance 100 can include a generative AI module. Alternatively, the server 500 or the home appliance 100 can interpret the input command using the generative AI module disposed in an external server.

The generative AI module 300 first interprets whether the input command is 1) related to the control of the home appliance, and 2) when the input command is related to the control of the home appliance, the generative AI module 300 can use sample texts or guides provided by the server 500 to generate intent control commands and slot control commands. Alternatively, the generative AI module 300 can generate a result that instructs the execution of a specific routine stored in the server 500.

The specific routine corresponds to a situation in which an input command is a command that instructs a predefined situation, that is, a routinized command, and the server 500 or the home appliance 100 can acquire intent control commands and slot control commands related to the predefined situation from the database.

For example, when the predefined routine is “exercise,” even when the user says the word “home training,” “running,” or “cycle” the generative AI module 300 interprets the word as “exercise,” and the server 500 or the home appliance 100 can execute a function of an exercise routine.

In addition, the personalized routine can also be stored. Even when the user sets its own routines in the home appliance 100 and inputs words for the corresponding routines, these routines can be stored on the home appliance 100 or the server 500. In addition, when the user says a specific word to invoke such a personalized routine, the generative AI module 300 can interpret the specific word.

When the command indicates a non-predefined situation, that is, a non-routinized command, the generative AI module 300 can extract the most similar command among the pre-stored routines or generate an intent control command and a slot control command based on the interpretation result of the input command.

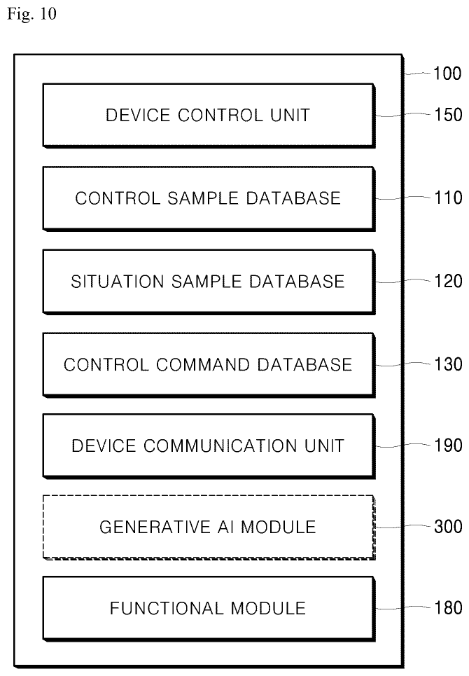

FIG. 10 is a view showing a configuration of the home appliance according to one embodiment of the present invention.

The structure of FIG. 10 is similar to that of the server 500. However, the home appliance 100 differs from the server 500 in that it provides a specific function.

The home appliance 100 includes a device control unit 150, a control sample database 110, a situational sample database 120, a control command database 130, and a device communication unit 190 (e.g., communication interface, or transceiver). In addition, the server 500 optionally includes the generative AI module 300. That is, the generative AI module 300 can be implemented within the home appliance 100 or in an external device (e.g., the server 500 or an external provider).

A functional module 180 provides unique functions of the home appliance 100. For example, when the home appliance 100 is an air conditioner, the functional module 180 includes both indoor and outdoor units (e.g., the air handler with evaporator coils, and the condenser). When the home appliance 100 is an oven, the functional module 180 includes a component for heating. When the home appliance 100 is a refrigerator, the functional module 180 includes a component that provides freezing and refrigeration functions.

Depending on the implementation method of the home appliance 100, the functional module 180 can be configured separately, and the device control unit 150 (e.g., device controller, or processor) and other components 110, 120, 130, 190, and optionally 300 can be configured using one or more software or hardware units. According to one embodiment of the present invention, the device control unit 150 (e.g., controller) and other components 110, 120, 130, 190, and optionally 300 can be implemented as a single chip.

The device control unit 150 determines, for the input command, which category the input command belongs to or which control command the input command corresponds to and generates a corresponding control command. During the determination process, the device control unit 150 can input predetermined information into the generative AI module 300.

The databases 110 and 120 can store multiple sample texts. In addition, among the databases, the situational sample database 120 can store predefined routines.

The device communication unit 190 (e.g., communication interface, or transceiver) communicates with other devices (e.g., other servers or portable terminals). When the generative AI module 300 is disposed in an external device (external server), the device communication unit 190 also communicates with the external device.

The device control unit 150 determines whether the command input to the home appliance 100 corresponds to direct control.

When the determination result indicates that the input command does not correspond to the direct control, the device control unit 150 extracts sample texts having similarity greater than or equal to a predetermined reference value with the input command from the database 120 and inputs the sample texts to the generative AI module 300.

When the input command corresponds to the direct control (e.g., a direct control command), the device control unit 150 can generate a control command corresponding to the input command without inputting the input command to the generative AI module 300.

When the input command corresponds to post-interpretational control in the result generated by the generative AI module 300 (e.g., a non-direct control command), the device control unit 150 generates a control command using the generated result. This refers to the category description of FIG. 4.

In addition, the home appliance 100 controls the functional module 180 to provide a function according to the generated control command.

By applying the embodiments of the present invention, speech recognition errors can be improved, enabling flexible recognition of user's commands. In addition, through situation-specific customized control, multiple functions of the home appliance can be controlled and operated with a single utterance command. In addition, when the user inputs not only defined keywords or control sentences, but also undefined keywords or non-control sentences, the server 500 can recognize the keywords and the sentences and control the home appliance. In addition, routines pre-stored in the server (e.g., ThinQ routines) can be executed as voice/text command utterances.

In addition, the separate generative AI module (300) (e.g., ChatGPT API) can be used to improve the voice recognition function of the home appliance, enabling recognition of utterances that would not be recognized based on existing defined commands. In addition, when the utterance invokes the ThinQ routine, which is a custom mode of a customer, the routine stored in the server (e.g., a routine stored in the ThinQ Cloud server) can be used to control the home appliance.

Various data that the prompt can include, that is, data included in the prompt can include identification information on the home appliance of the user and configuration information of the home appliance of the user. For example, the identification information on the home appliance is information on a home appliance registered to a server, a home appliance registered to the user's account within the server, and the like as a device the user actually owns in one embodiment.

In order to generate accurate prompts, the prompt can include important information for each home appliance, that is, various information on the configuration of the home appliance.

According to one embodiment of the present invention, there is provided a method of controlling a home appliance based on a command, including a first operation of determining, by a server or a home appliance, whether an input command corresponds to direct control, a second operation of extracting, by the server or the home appliance, sample texts having similarity greater than or equal to a predetermined reference value with the input command from a database and inputting the sample texts to a generative artificial intelligence (AI) module when the input command does not correspond to the direct control in the first operation, a third operation of generating, by the server or the home appliance, a control command using the generated result when the input command corresponds to post-interpretational control in a result generated by the generative AI module, and a fourth operation of providing, by the home appliance, a function according to the generated control command.

According to one embodiment of the present invention, there is provided a server for controlling a home appliance based on a command, including a server control unit configured to determine an input command and generate a corresponding control command, a database which stores a plurality of sample texts, and a server communication unit configured to communicate with a home appliance, in which the server communication unit receives a command inputted to the home appliance from the home appliance, the server control unit determines whether the command inputted to the home appliance corresponds to direct control, and when the input command does not correspond to the direct control, the server control unit extracts a sample text having similarity greater than or equal to a predetermined reference value from the database and inputs the sample text to a generative artificial intelligence (AI) module, when the input command corresponds to post-interpretational control in the result generated by the generative AI module, the server control unit generates a control command using the generated result, and the server communication unit transmits the control command to the home appliance so that the home appliance provides a function according to the generated control command.

Even though all components constituting the embodiments of the present invention have been described as being coupled or coupled and operated, the present invention is not necessarily limited to these embodiments, and one or more of all components can be selectively coupled and operated without departing from the scope of the present invention. In addition, each of the components can be implemented as a single, independent hardware, but some or all of the components can be selectively coupled and implemented as a computer program having program modules that perform some or all of the combined functions of one or more hardware units. The codes and code segments constituting the computer program can be easily inferred by those skilled in the art. Such a computer program can be stored in a computer-readable storage medium and read and executed by a computer, thereby implementing the embodiments of the present invention. The storage media for computer programs include magnetic recording media, optical recording media, and storage media including semiconductor recording devices. In addition, a computer program implementing the embodiments of the present invention includes program modules transmitted in real time through an external device.

The above description focuses on the embodiments of the present invention, but various changes and modifications can be made within the scope of those skilled in the art. Accordingly, it will be understood that these changes and modifications are included within the scope of the present invention as long as they do not depart from the scope of the present invention.

What is claimed is:

1. A method of controlling an electronic device, the method comprising:
receiving, by a controller in the electronic device, a user input;
determining, by the controller, whether the user input corresponds to a direct control command or a non-direct control command;
in response to the user input corresponding to the direct control command, executing, by the electronic device, a function corresponding to the direct control command;
in response to the user input corresponding to the non-direct control command, extracting at least one sample text from a database having a similarity score relative to the user input that is greater than or equal to a predetermined threshold, and providing a prompt to a generative artificial intelligence (AI) module, the prompt including the user input, a guide associated with a command category, and the at least one sample text;
receiving, from the generative AI module, a result based on the prompt for generating a control command, the result including an interpreted command category; and
executing, by the electronic device, a function corresponding to the control command.

2. The method of claim 1, wherein the electronic device is a home appliance.

3. The method of claim 1, wherein the similarity score is based on BM25 or cosine similarity.

4. The method of claim 1, further comprising generating, by the electronic device, the control command using the result when the user input corresponds to post-interpretational control in the result generated by the generative AI module.

5. The method of claim 1, further comprising generating, by the electronic device, the control command corresponding to a routine included in the result when the user input corresponds to post-interpretational control in the result generated by the generative AI module.

6. The method of claim 1, further comprising generating, by the electronic device, the control command to output the result via voice or text when the user input corresponds to post-interpretational chat in the result generated by the generative AI module.

7. The method of claim 1, further comprising generating the control command using an intent control command and a slot control command included in the result generated by the generative AI module.

8. The method of claim 7, wherein the at least one sample text includes one or more intent control commands and one or more slot control commands for controlling the electronic device.

9. The method of claim 8, wherein the at least one sample text includes a sentence for controlling the electronic device and a set of corresponding intent control commands and slot control commands.

10. The method of claim 8, wherein the set of corresponding intent control commands and slot control commands is configured to instruct a function to be performed by the electronic device.

11. The method of claim 1, wherein the user input is a natural language voice command,
wherein the prompt further includes a base that defines an operational context and a required output structure for the generative AI module, and
wherein the guide is configured to constrain the generative AI module by providing a predefined list of command categories from which the interpreted command category is selected.

12. A server for controlling a home appliance, the server including:
a database storing a plurality of sample texts; and
a controller configured to:
receive a user input from the home appliance,
extract at least one sample text from a database having a similarity score relative to the user input that is greater than or equal to a predetermined threshold,
provide a prompt to a generative artificial intelligence (AI) module, the prompt including the user input, a guide associated with a command category, and the at least one sample text;
receive, from the generative AI module, a result based on the prompt for generating a control command, the result including an interpreted command category; and
transmit the control command to the home appliance for executing a function corresponding to the control command.

13. The server of claim 12, wherein the similarity score is based on BM25 or cosine similarity.

14. The server of claim 12, wherein the controller is further configured to generate the control command using the result when the user input corresponds to post-interpretational control in the result generated by the generative AI module.

15. The server of claim 12, wherein the controller is further configured to generate the control command corresponding to a routine included in the result when the user input corresponds to post-interpretational control in the result generated by the generative AI module.

16. The server of claim 12, wherein the controller is further configured to generate the control command to output the result via voice or text when the user input corresponds to post-interpretational chat in the result generated by the generative AI module.

17. The server of claim 12, wherein the controller is further configured to generate the control command using an intent control command and a slot control command included in the result generated by the generative AI module.

18. The server of claim 17, wherein the at least one sample text includes one or more intent control commands and one or more slot control commands for controlling the home appliance.

19. The server of claim 18, wherein the at least one sample text includes a sentence for controlling the home appliance and a set of corresponding intent control commands and slot control commands.

20. A non-transitory computer readable medium storing computer-executable instructions that when executed by a processor, cause the processor to perform the operations of:
receiving a user input;
determining whether the user input corresponds to a direct control command or a non-direct control command;
in response to the user input corresponding to the direct control command, executing a function corresponding to the direct control command;
in response to the user input corresponding to the non-direct control command, extracting at least one sample text from a database having a similarity score relative to the user input that is greater than or equal to a predetermined threshold, and providing a prompt to a generative artificial intelligence (AI) module, the prompt including the user input, a guide associated with a command category, and the at least one sample text;
receiving, from the generative AI module, a result based on the prompt for generating a control command, the result including an interpreted command category; and
executing a function corresponding to the control command.
